(19) United States
(12) Patent Application Publication
(10) Pub. No.: US 2007/0212190 A1
(43) Pub. Date: Sep. 13, 2007

(54) Low profile fastening system

(76) Inventors: John S. Monday, Laguna Beach, CA (US); Karen Monday, Laguna Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/656,133

(22) Filed: Jan. 22, 2007

Related U.S. Application Data
(60) Provisional application No. 60/760,809, filed on Jan. 20, 2006.

(51) Int. Cl. F16B 27/00

(52) U.S. Cl. 411/85

(57) ABSTRACT

Described herein are embodiments of fastening systems that can provide easily removed and reapplied fasteners and that provide a hindrance to those that might tamper with the fasteners. In some embodiments, fasteners are also described that are configured to reduce the accumulation of dust and dirt inside the fasteners. In further embodiments, fasteners are provided for improving the aerodynamics of the fastener, and some embodiments describe provision of commercial advertising or other messages on the fastener.

### RELATED APPLICATIONS

This Application claims priority benefit of U.S. Provisional Application No. 60/760,809, filed Jan. 20, 2006; entitled, “Low Profile Fastening System,” the entirety of which is incorporated herein by reference.

### FIELD OF THE INVENTIONS

The present disclosure relates to fasteners and drivers, and more particularly to fasteners and drivers that are configured to have security features.

### BACKGROUND OF THE INVENTIONS

Fasteners are used is several industries and for several purposes. For example, in aerospace, fasteners are used to secure together portions of aircraft or spacecraft. Fasteners are used to secure portions of the body together in surgical uses, and they are used to bind structures together in industrial applications. Fasteners that are used are bolts, rivets, screws, and nails.

### SUMMARY OF THE INVENTIONS

One existing problem with many fasteners is that once they are applied, they are functionally irremovable. For example, rivets and nails, once applied, cannot easily be removed and reapplied. Another problem is that many fasteners are removed or applied by the use of common tools. For example, bolts and screws present easy targets for those that might tamper with fasteners.

Described herein are embodiments of fastening systems that can provide easily removed and reapplied fasteners and that provide a hindrance to those that might tamper with fasteners. In some embodiments, fasteners are also described that are configured to reduce the accumulation of dust and dirt inside the fasteners. In further embodiments, fasteners are provided for improving the aerodynamics of the fastener, and some embodiments describe provision of commercial advertising or other messages on a fastener.

In some embodiments, a security fastener is described having a head with a recessed top with a circumferential wall. The circumferential wall preferably has a plurality of indentations therein that are spaced below an upper edge of the wall to permit engagement of the fastener by a tool with retractable projections that are matable with the indentations. In some embodiments, the fastener further includes a cap that is sized and configured to be received within the recessed top. The cap can include an indentation in a side for providing a pry hole. Preferably, the indentation can be concealed when the cap is inserted into the recessed top. In some embodiments, a fastening system is provided that includes the tool with which the fastener is used.

In some embodiments, a security fastener driver is provided. The driver is for driving a security fastener that includes a head having a recessed top with a circumferential wall. The circumferential wall preferably has a plurality of indentations therein spaced below an upper edge of the wall to permit engagement of the fastener by the driver. The fastener further includes a cap that is sized and configured to be received within the recessed top. The cap preferably includes an indentation in a side of the cap for providing a pry hole. The indentation is preferably concealed when the cap is initially inserted into the recessed top. The security fastener driver includes a plurality of elongate arms that extend in a longitudinal direction. The elongate arms further include distal portions that extend generally transverse to the longitudinal direction and are movable generally transverse to the longitudinal direction such that said distal portions are configured to extend into the indentations of the circumferential wall and engage the fastener. The driver further includes an actuatable member that is configured to move in the longitudinal direction to move the elongate arms transverse to the longitudinal direction to engage and disengage the distal portions with the fastener.

The above-summary is offered to merely provide a brief description of some embodiments described herein. The summary is not intended to list all novel embodiments, and the claims and the description below should not be limited by the above summary.

### BRIEF DESCRIPTION OF THE DRAWINGS

The aspects and advantages of the present disclosure will be described with reference to the drawings of several preferred embodiments, which embodiments are intended to illustrate and are not intended to limit the invention.

FIG. 1 is an exploded isometric view of an embodiment of a fastener in accordance with the disclosure contained herein.

FIG. 2 is an exploded isometric view of another embodiment of a fastener.

FIG. 3 is an exploded isometric view of another embodiment of a fastener with a logo imprinted on a cap portion.

FIG. 4 is an isometric view of the fastener of FIG. 3 with the cap portion coupled to the fastener.

FIG. 5 is an exploded isometric view of an embodiment of a fastener.

FIG. 6 is an exploded isometric view of another embodiment of a fastener.

FIG. 7 is an exploded isometric view of another embodiment of a fastener.

FIG. 8 is an exploded isometric view of another embodiment of a fastener.

FIG. 9 is a cross-sectional plan view of one embodiment of a fastener and a cap portion attached thereto.

FIG. 10 is a cross-sectional plan view of another embodiment of a fastener and a cap portion attached thereto.

FIG. 11 is a cross-sectional plan view of another embodiment of a fastener and a cap portion attached thereto.

FIG. 12 is an isometric view of an embodiment of a driver and fastener in accordance with the disclosure contained herein.

FIG. 13 is an isometric view of a driver engaging a fastener in accordance with the disclosure contained herein.

FIG. 14 is an isometric view of another embodiment of a driver.

FIG. 15 is a bottom view of the driver of FIG. 9.

FIGS. 16a-16f are isometric views of embodiments of prongs of a driver.

FIG. 17 is an isometric view of another embodiment of a driver engaging a fastener.

FIG. 18 is a partial cross-sectional view of an embodiment of a driver and fastener in accordance with the disclosure contained herein.

FIG. 19 is a partial cross-sectional view of a driver engaging a fastener in accordance with the disclosure contained herein.

### DESCRIPTION OF THE PREFERRED EMBODIMENTS

With reference to the figures, certain embodiments will be described, which embodiments provide fasteners, such as screws, that are configured to reduce the accumulation of dust and dirt inside the fastener, to provide a tamper resistant system, to increase the aerodynamics of the fastener, and to provide commercial advertising or other messages on the fastener.

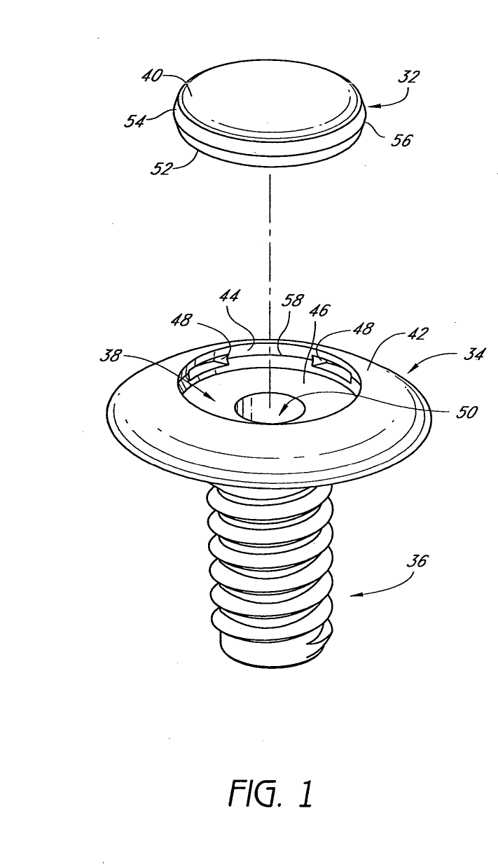

With initial reference to FIG. 1, one embodiment of a fastener 30 is illustrated, wherein the fastener includes a cap 32, a head 34, and a threaded portion 36. The head 34 includes a recessed portion 38 into which the cap 32 may be disposed. When the cap 32 is disposed within the recessed portion 38 of the head 34, a top surface 40 of the cap 32 and a top surface 42 of the head 34 preferably cooperate to make a substantially uniform profile along the top of the head when assembled. The substantially uniform profile of the top surfaces 40, 42 provide several advantages. For example, the surfaces provide an increased aerodynamic surface. In surgical applications, the smooth profile of the top surfaces 40, 42 can facilitate body tissue to pass over the top of the fastener 30 while reducing the friction between the fastener 30 and the tissue. When the cap 32 is disposed within the recessed portion 38, accumulation of dirt and dust is reduced within the recessed portion 38, thereby preserving the utility of the fastener 30. Additionally, the cap 32 may be disposed within the recessed portion 38 to provide a tamper resistant fastener 30 by limiting access to the recessed portion 38. Further advantages and embodiments will be described herein.

The recessed portion 38 is preferably located on the top surface 42 of the head 34. The recessed portion 38 includes a wall 44 that extends between the top surface 42 and a recessed base 46. Disposed within the wall 44 are preferably a plurality of slots 48. A recessed hole 50 is preferably disposed in the recessed base 46 extending away from the top surface 42 of the head 34.

The cap 32 preferably has a bottom surface 52 on an opposing side of the top surface 40. A cap edge 54 preferably extends between the bottom surface 52 and the top surface 40 around the periphery of the cap 32. In one embodiment, as illustrated in FIG. 1, the cap edge 54 includes a middle portion 56 that protrudes from the cap 32 around the periphery of the cap edge 54, such that the circumference of the middle portion 56 is greater than the circumference of the top surface 40. The circumference of the middle portion 56 preferably is also greater than the circumference of the bottom surface 52. The wall 44 preferably has a corresponding profile to accommodate the cap edge 54 when the cap 32 is disposed within the recessed portion 38. For example, in the illustrated embodiment of FIG. 1, the recessed edge preferably includes a middle portion 58 that extends along the periphery of the wall 44. The middle portion 58 of the wall 44 preferably has a greater circumference than the circumference of the top surface 42 along the wall 44. In some embodiments, the middle portion 58 may also have a greater circumference than the circumference of the wall 44 along the recessed base 46. Accordingly, the profile of the cap edge 54 corresponds to the profile of the wall 44, thus permitting the cap 32 to be disposed within the recessed portion 38. When the cap 32 is disposed within the recessed portion 38, the smaller circumference of the top surface 42 around the wall 44 limits the cap 32 from being removed by engaging the corresponding middle portion 56 of the cap edge 54.

In application, after the fastener 30 is applied to the desired material by the threaded portion 36, the cap is brought adjacent to the recessed portion 38 and the cap 32 is pressed down into the recessed portion 38 until the cap 32 snaps into place within the recessed portion 38. In one embodiment, the cap 32 is made of or includes a softer material than that of the head 34. For example, in some embodiments, the cap 32 may include a softer metal or a polymer. In this way, a portion of the cap 32 may be elastically deformed upon insertion into the head 34 of the fastener 30. In other embodiments, the cap 32 is made of or includes the same material as the head 34. In some embodiments the base of the cap 32 may be substantially hollow to permit the sides of the cap 32 to flex inward during insertion or removal of the cap into or from the recessed portion 38. The cap 32 may be molded, machined, or formed in ways that will be readily apparent to one of ordinary skill in the related art. The cap 32 may be made of one material or may include a plurality of materials. For example, the cap 32 may be made of two materials, one material for the portion of the cap 32 that substantially includes the top surface 40 and bottom surface 52 and a second material for the cap edge 54 or the middle portion 56. In this embodiment, the second material may be more compliant than the first material, thus facilitating insertion of the cap 32 into the recessed portion 38. In one embodiment, the middle portion 56 may be made of a rubber that is compressed during insertion and removal of the cap. In yet further embodiments, the middle portion 56 can be similar to a snap ring that is configured to expand or contract during application. For example, the middle portion 56 may include a discontinuous portion that permits the middle portion 56 to expand or contract upon the application of pressure.

In some embodiments, a tool may be provided for inserting the cap 32 into the recessed portion 38. For example, the tool may be secured or positioned on the head 34 of the fastener 30 and can facilitate the application of pressure to insert the cap 32 into position. The tool may also operate to facilitate insertion of the cap 32 into the head 34 of the fastener 30 without being secured or positioned on the head 34.

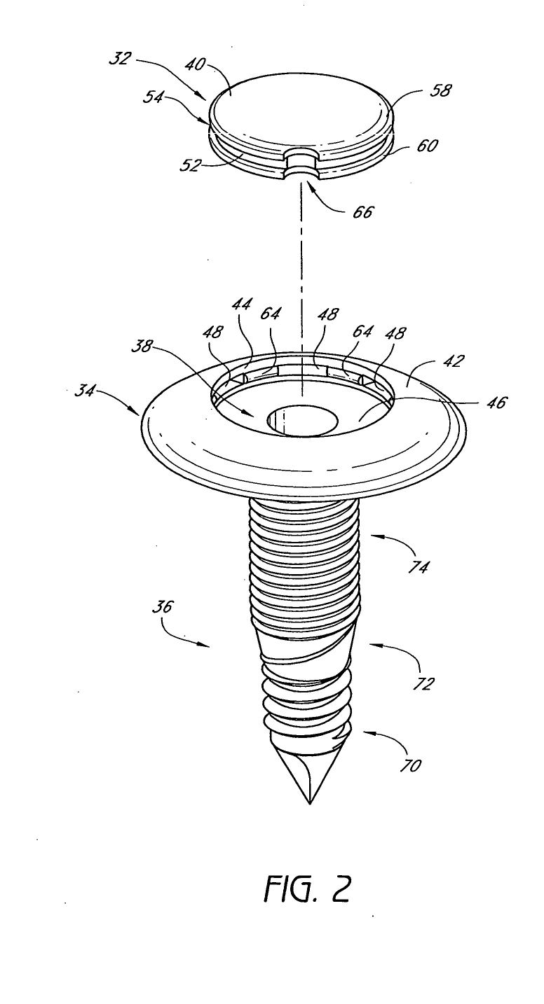

With reference to FIG. 2, another embodiment of a cap 32 is illustrated having a different edge cap profile than that illustrated in FIG. 1. In FIG. 2, the cap edge 54 preferably includes a first ridge 58 axially spaced from a second ridge 60. The first ridge 58 and the second ridge 60 are preferably separated by an edge channel 62 that extends circumferentially about the cap edge 54. The first ridge 58 and the second ridge 60 preferably have a greater circumference than the edge channel 62. The wall 44 of the head 34 preferably includes a plurality of wall ridges 64 that are disposed along the periphery of the wall 44 and which extend radially inward of the recessed portion 38. The wall ridges 64 are preferably axially spaced from the recessed base 46 and the top surface 42. The wall ridges 64 are preferably configured to be received within the edge channel 62 when the cap 32 is disposed within the recessed portion 38. Accordingly, when the cap 32 is pressed into place within the recessed portion 38, the second ridge 60 is disposed beneath the wall ridges 64 of the wall 44, and axial movement of the cap 32 is limited. When the cap 32 is disposed within the recessed portion 38, the wall ridges 64 preferably reside within the edge channel 62, and the wall ridges 64 engage or are engageable with the second ridge 60 to limit removal of the cap 32.

In one embodiment, the cap 32 and the head 34 are made of the same material. In other embodiments, the cap 32 and the head 34 may be made of different materials. For example, in one embodiment, the head 34 may be made of a metal, and the cap 32 may be made of a polymer. In yet further embodiments, the cap 32 or the head 34 may each be made of different materials. For example, the cap 32 may be made of a metal material, and the first and second ridges 58, 60 may be made of a polymer. In another example, the head 34 may be made of a metal, and the wall ridges 64 may be made of a polymer.

The cap 32 may include an axially extending semi-cylindrical notch 66 disposed along the cap edge 54 between the top surface 40 and the bottom surface 52. The notch 66 is preferably configured to provide a space between the cap edge 54 and the wall 44 when the cap 32 is disposed within the recessed portion 38. In this embodiment, the notch 66 provides a pry hole which a person can use to pry the cap 32 from the recessed portion 38. While the notch 66 is described and depicted as an axially extending semi-cylindrical shape, the notch 66 can have other shapes. For example, the notch 66 can have a triangular or other polygonal or irregular shapes.

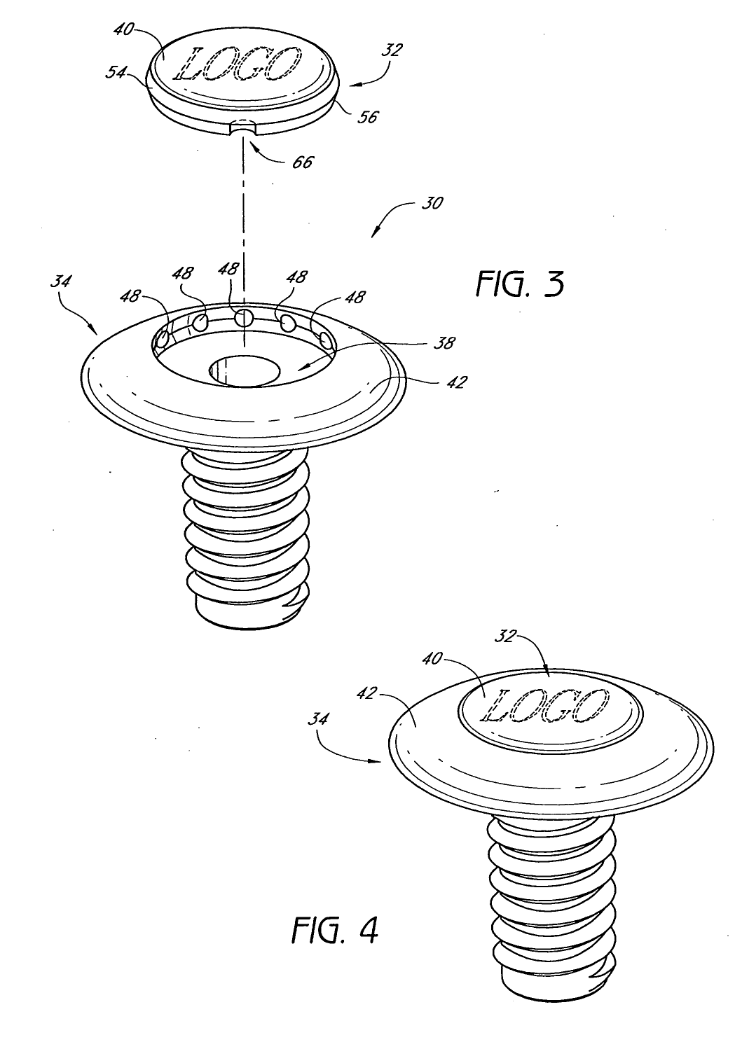

In some embodiments, as illustrated in FIG. 3, the notch 66 may extend only part way through the cap edge 54. For example, FIG. 3 illustrates a cap 32 having a partial notch 66 that extends from the middle portion 56 to the bottom surface 52. The partial notch does not extend from the middle portion 56 to the top surface 40. In this embodiment, when the cap 32 is disposed within the recessed portion 38, the notch 66 is not visible to one looking at the fastener 30. The notch 66 may be used as a pry hole by punching through or breaking the material extending from the middle portion 56 to the top surface 40 above the notch 66. By puncturing the material above the notch 66, a notch 66 will be created that extends from the top surface 40 to the bottom surface 52, in which an instrument can be inserted to pry the cap 32 from the recessed portion 38. In the embodiment illustrated in FIG. 2, the notch 66 can extend through the second ridge 60, but not entirely through the first ridge 58. In some embodiments, the notch 66 can extend through about 50% of the material of the cap 32 or ridge 58. In other embodiments, the notch 66 can extend through between about 25% and about 95% of the material of the cap 32 or ridge 58. In yet further embodiments, the notch 66 can extend through less than about 25% or more than about 95% of the material of the cap 32 or ridge 58. Accordingly, the material of the first ridge 58 may be punctured, thereby permitting access to the notch 66 to dislodge the cap 32 from the recessed portion 38.

In some embodiments, the cap 32 may have a visual indicator located above the notch 66 that indicates where a notch may be created by punching through or breaking the material. The visual indicator can be an indentation or protrusions in the material above the notch 66, or the indicator can be provided after manufacturing. For example, the indicator may be painting or etched on the material. Additionally, in some embodiments, the cap 32 provides an indentation to receive the material when the notch 66 is created by punching or breaking through the material. For example, the cap 32 may include a radially extending indentation that permit the material to be received when the material folds down when exposing the notch 66.

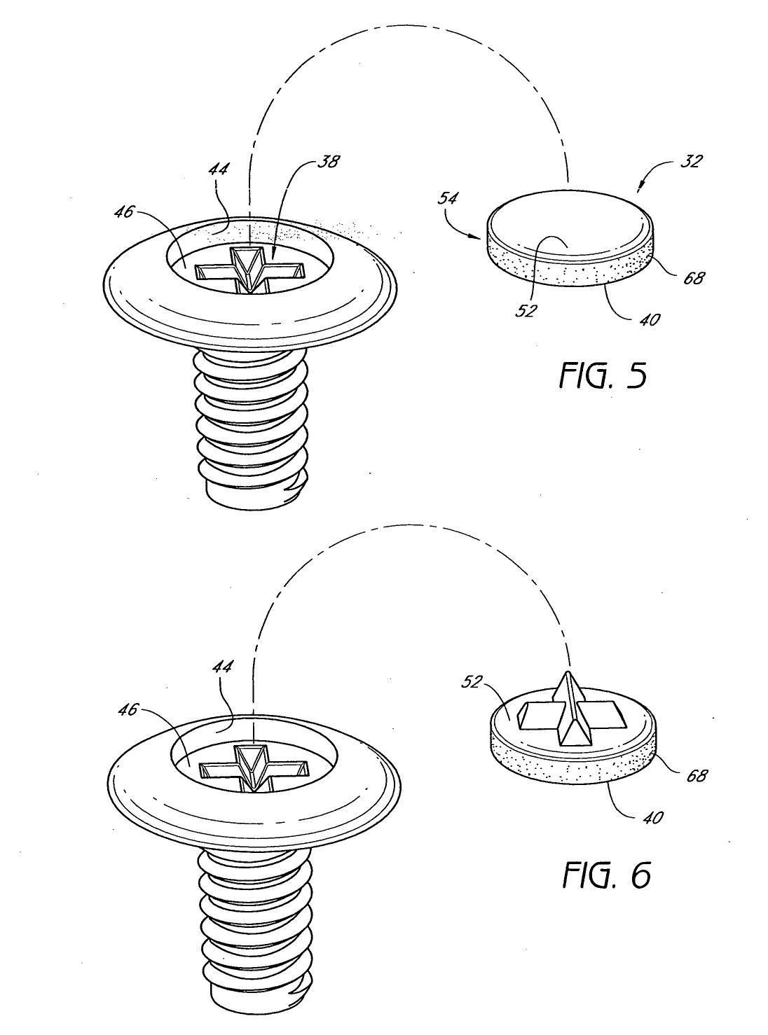

With reference to FIG. 5, the cap 32 can have a cap edge 54 that extends parallel to an axis of the cap 32 or an axis of the fastener 30. The wall 44 may also extend between the top surface 42 and the recessed base 46 parallel to an axis extending through the cap 32 or the fastener 30. Accordingly, the cap 32 can be configured to fit within the recessed portion 38 without requiring engagement of the cap edge 54 within the wall 44. In this embodiment, adhesive 68 can be disposed along the periphery of the cap edge 54 such that when the cap 32 is disposed within the recessed portion 38, the adhesive 68 couples the cap edge 54 with the wall 44 to secure the cap 32 in place. The adhesive 68 can also be disposed one the bottom surface 52 of the cap 32 to secure the cap 32 in place.

The cap 32 and the recessed portion 38 in the figures are illustrated as having a generally cylindrical shape. In some embodiments, the cap 32 and the recessed portion 38 can have different shapes. For example, the cap 32 may have a triangular, rectangular, pentagonal, hexagonal, or other polygonal or irregular shapes. The recessed portion 38 preferably has a shape that corresponds to the shape of the cap 32. Additionally, the cap 32 is depicted in the figures as having a smooth or rounded top surface 40. In some embodiments, the top surface 40 can be beveled, conical, or other shapes. While the cap edge 54 and wall 44 have been described in various embodiments, such description should not limit the scope of the disclosure of the fastener 30. The cap edge 54 and the wall 44 may have several different profiles that will permit the cap to be snap-fitted within the recessed portion 38. Such alternative embodiments are herein contemplated and are within the breadth of this disclosure.

With reference to FIGS. 3 and 4, the cap 32 may also include a logo displayed on the top surface 40. In one embodiment, the logo is an advertisement, permitting the logo to be visible when the fastener 30 is used. In another embodiment, the logo can include a design for decorative purposes. In yet further embodiments, the logo may be used to designate a particular use or purpose for which the fastener 30 is used. For example, the logo may be used to designate handicapped, or disabled, facilities.

With reference to FIGS. 1, 2, and 3, the slots 48 are preferably configured to receive a tool therein to operate the fastener 30. For example, in FIGS. 1 and 2, the slots 48 are depicted as rectangular holes or channels disposed along the periphery of the wall 44. The slots 48 are thus configured to receive a prong on a driver, described herein, to rotate the fastener 30 into place. In one embodiment, the fastener 30 has at least one slot 48 for operating the fastener 30. In other embodiments, the fastener 30 may have anywhere between 2 and 10 slots 48. In yet further embodiments, the fastener 30 may have 2, 3, 4, 5, 6, or 8 slots 48. In additional embodiments, the fastener 30 may have more than 10 slots. The slots may be configured in a number of shapes that preferably correspond to the shape of the tool that will be inserted therein to operate the fastener 30. For example, as illustrated in FIG. 3, the slots 48 can also have a circular shape. Additional shapes will be described herein with respect to the tool that is used to be inserted within the slots 48, and corresponding slots 48 are preferably disposed within the recessed edge 48 to accommodate the shape of the tool.

The threaded portion 36 of the fastener 30 can have a variety of thread types. Threads that can be used for a variety of material can also be used with respect to the fastener. For example, threads may be used for wood, sheet metal, plastics, or other applications. The threaded portion 36 may have a self-tapping portion 70, as depicted in FIG. 2. In some embodiments, the fastener 30 is configured for use with respect to rivet replacements (e.g., aircraft rivet replacement). In some embodiments, the fastener may have a plurality of portions along the threaded portion 36 that have different functions when used with respect to fastening materials together. For example, with respect to FIG. 2, the threaded portion 36 includes a self-tapping portion 70, a transitional portion 72, and a fine threaded portion 74, which operates as a thread lock pattern disposed under the head 34. Accordingly, as the fastener is inserted into the material, the self-tapping portion 70 taps into the material and widens the aperture that is disposed in the material through the transition portion 72, and the fine threaded portion 74 cooperates with the self-tapping portion 70 to secure the fastener 30 in place.

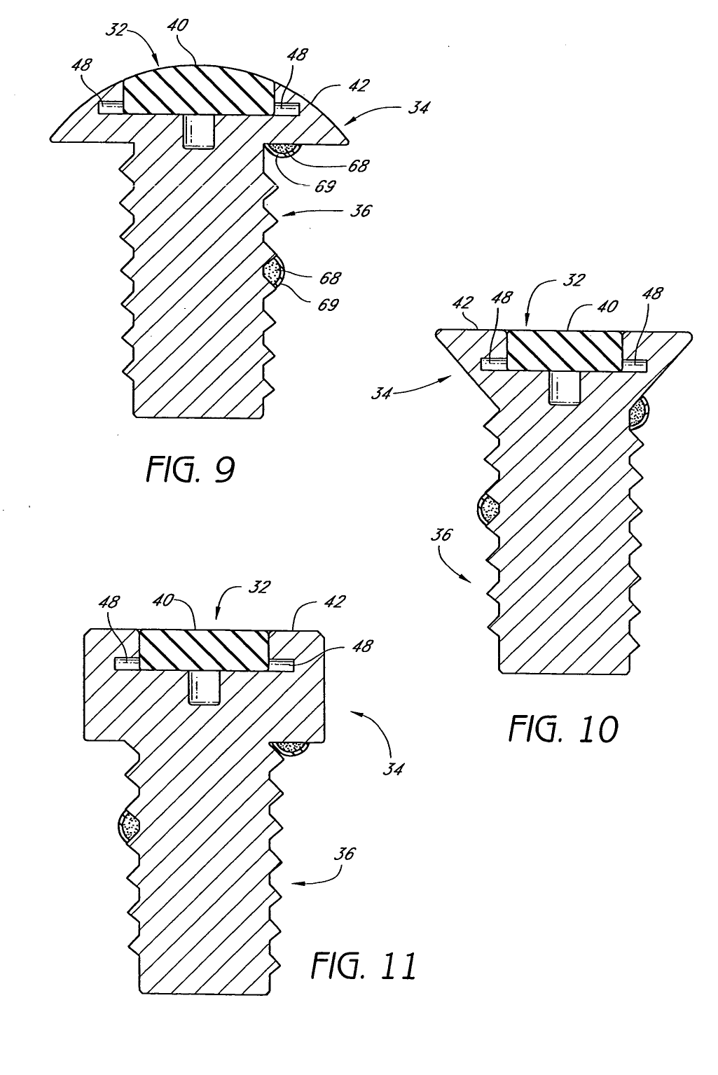

In other embodiments, the threads may include one or more adhesive pockets that include an adhesive 68 and a skin 69 for securing the fastener 30 in place. For example, FIGS. 9-11 depict a fastener having a plurality of adhesive pockets that include adhesive 68 surrounded by a skin layer 69 to contain the adhesive 68. The skin layer 69 may be made of a soft or malleable metal, a polymer, or other material that can break or tear when the fastener 30 is used. In application, as the fastener 30 is applied, the skin layer 69 is configured to break or tear and release the adhesive 68 contained therein. The adhesive pocket on the threaded portion 36 can distribute adhesive 68 among the threads of the fastener 30 and secure the fastener 30 in place once the adhesive 68 solidifies. The adhesive pocket on the underside of the head 34 can break or tear as the head 34 approaches the material into which the fastener 30 is being inserted. The adhesive secures the head 34 of the fastener 30 to the material into which the fastener 30 is inserted. Accordingly, adhesive 68 can be provided with the fastener 30 and can be used in a single step of applying the fastener 30 to assist with securing the fastener 30 in place.

In another embodiment, the adhesive 68 depicted in FIGS. 9-11 can be a homogeneous material that does not require a distinct skin layer 69 for application on the fastener 30. For example, the adhesive 68 can be a material that will remain substantially in place following application of the adhesive 68 to the fastener 30. Glue that hardens on the surface without hardening throughout could be used in such an application.

In other embodiments, the material within the skin layer 69 may include an anti-seize agent or an anti-corrosion agent. For example, the anti-seize agent can be used in applications in which the fastener 30 is intended to be removed at least once. The anti-corrosion agent may be used with the adhesive 68 or the anti-seize agent, and may reduce the likelihood that the fastener 30 or the material into which the fastener 30 is placed will be corroded.

FIGS. 9-11 depict the slots 48 at 90 degrees with respect to the recessed portion 38 and substantially parallel with the recessed base 46. In some embodiments, the slots 48 may extend into the head 34 at an angle different than 90 degrees with respect to the recessed portion 38 or parallel with the recessed base 46. For example, in one embodiment, the slots 48 can extend at 45 degrees with respect to the length-wise axis of the fastener or with respect to the recessed base 46. In another embodiment, the slots 48 can extend between about 30 degrees and about 60 degrees with respect to the fastener axis or with respect to the recessed base 46. In other embodiments, the slots 48 can extend less than about 30 degrees or greater than about 60 degrees with respect to the fastener axis or with respect to the recessed base 46. In yet further embodiments, the angle of the slots 48 provided above may be with respect to the top surface 42 of the head 34 or other portions of the fastener.

Incorporating angled slots 48 in the fastener 30 can provide several advantages. For example, angled slots 48 can ease manufacture of the fastener 30 facilitating insertion of a drill within the recessed portion 38 at an angle to drill or machine the slots 48. Additionally, the angled slots 48 may facilitate coupling of a driver during operation. As the fastener 30 and a driver can be coupled together during the application of the fastener 30, the driver can be used with one hand or can even be robotically applied. For example, once the driver engages the slots 48 of the fastener 30, the fastener 30 is less likely to be dropped during the application. The coupling feature of the fastener 30 and the driver can be used in microapplications, including surgical applications.

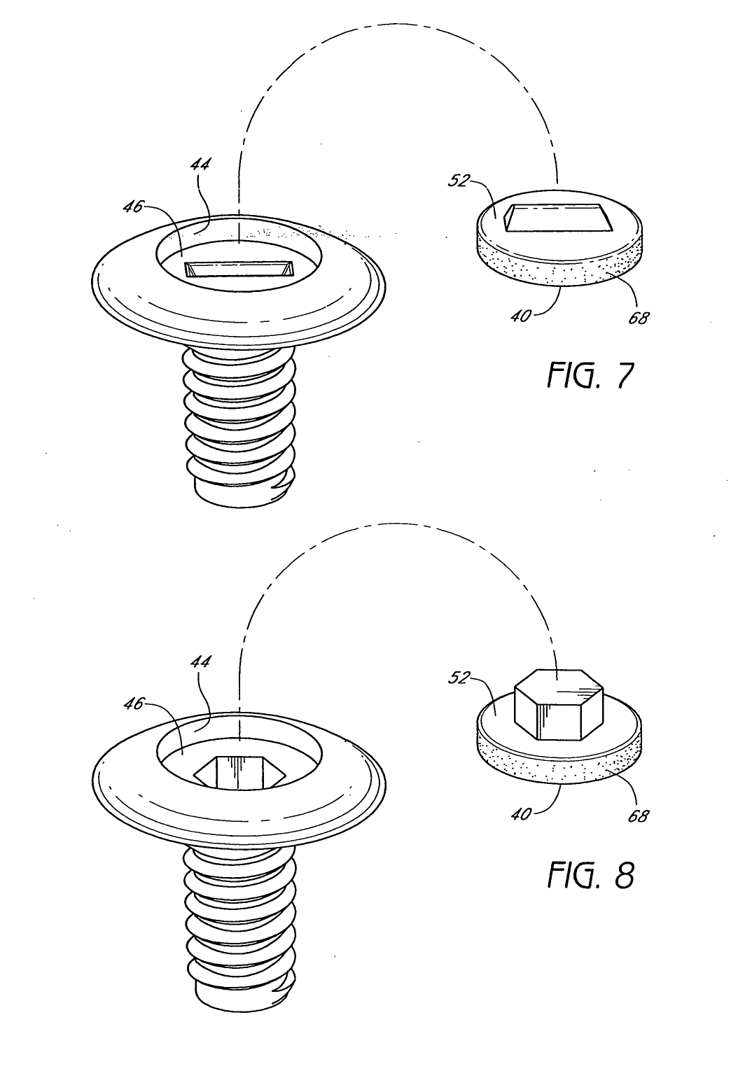

With reference to FIGS. 5 through 8, the fastener 30 may also be used with respect to Phillips screwdrivers, flat-head screwdrivers, Allen wrenches, and other tools used with fastening devices. In these embodiments, the recessed base 46 preferably includes a Phillips screw recess, a flat-head recess, an Allen wrench recess, or some other recess that corresponds to the tool that is used to operate the fastener 30. The cap 32 can include a protrusion that corresponds to the Phillips screw recess, the flat-head screw recess, or the Allen wrench recess and is configured to be inserted within the recess. Accordingly, the fastener 30 may be configured to be used with tools other than those described herein. Although the caps 32 in FIGS. 5 through 8 are depicted as including an adhesive 68 on the cap edge 54, other cap edges may be used as discussed herein with respect to previous or later embodiments.

With reference to FIGS. 9 through 11, the fastener 30 may have different profiles. For example, FIG. 9 illustrates one embodiment in which the fastener and the cap form a substantially curvilinear top surface. In another embodiment, as illustrated in FIG. 10, the profile of the fastener 30 may be similar to that of a flat-head screw, in which the top surface of the fastener 30 in cap 32 are substantially flat. The underside of the head of the fastener 30 illustrated in FIG. 10 is preferably tapered from the top surface of the fastener 30 to the threaded portion 36. In yet another embodiment, as illustrated in FIG. 11, the head 34 of the fastener 30 may be similar to that of the knob-head screw. In this embodiment, the cross-sectional profile of the head 34 of the fastener 30 is substantially rectangular.

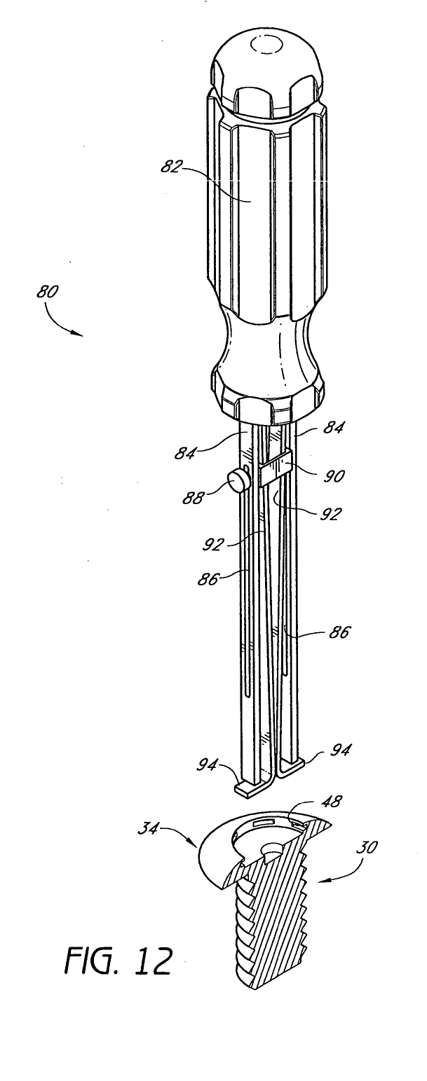

With reference to FIG. 12, a driver 80 is shown that can be used with the fasteners 30 described herein. In the illustrated embodiment, the driver 80 preferably includes a handle 82 on a proximal portion of the driver 80. A plurality of supporting struts 84 preferably extend distal of the handle 82 in parallel relation with each other. A plurality of supporting struts 84 preferably include an axially-extending elongated channel 86 extending from a proximal portion of the supporting strut 84 to a distal section of the supporting strut 84. Disposed within the elongated channel 86 is preferably an actuator 88 that is coupled to a collar 90, which extends between the plurality of supporting struts 84. Also disposed between the supporting struts 84 and extending the length of the supporting strut 84 are a plurality of prong struts 92 that can be coupled to the handle 82 on their proximal end and extend beyond the distal section of the supporting strut 84. The prong strut 92 includes a distal portion that extends about 90 degrees with respect to the prong strut 92. This distal portion preferably extends about one-half of the length of which the supporting struts 84 are separated. Accordingly, this distal portion can constitute a plurality of prongs 94 that extend beyond the periphery of the supporting struts 84. The prong struts 92 are preferably biased inward of the supporting struts 84 such that the prongs 94 are brought inward and the radial distance between the ends of the prongs 94 is reduced. When the actuator 88 and the collar 90 are in a proximal position, as illustrated in FIG. 12, the distal ends of the prong struts 92 are permitted to move inward, thereby reducing the radial distance between the ends of the prongs 94. This configuration can be a pre-deployment configuration in preparation for coupling the driver 80 with the head 34 of a fastener 30.

In some embodiments, the prongs 94 can extend at the distal portion at angles other than 90 degrees with respect to the prong strut 92. For example, the prongs 94 can extend at angles corresponding to the angle of the slots 48 of the fastener 30. In some embodiments, the prongs 94 can extend at about 45 degrees or about 135 degrees with respect to the prong struts 92. In some embodiments, the prongs 94 can extend between about 30 degrees and about 150 degrees with respect to the prong struts 92. In further embodiments, the prongs can extend at less than about 30 degrees and more than about 150 degrees with respect to the prong struts 92.

In application, the driver 80 is brought adjacent to the fastener 30, and the distal end of the supporting struts 84 is inserted into the recessed portion 38 of the head 34. When the distal portion of the supporting struts 84 is inserted into the recessed portion 38, the actuator 88 and the collar 90 are moved distally along the elongated channels 86. The collar 90 is preferably configured to press the portion of the prong strut 92 that is adjacent to the collar 90 against the inward wall of the supporting strut 94. This may be accomplished by a protrusion extending on the inward portion of the collar 90 between the prong struts 92. Accordingly, as the actuator 88 is moved distally along the elongated channel 86, the prong struts 92, which are biased inward, are forced against the inward wall of the supporting struts 84. As the prong struts 92 are forced against the inward wall of the supporting struts 84, the prongs 94 are moved to an outward position, in which the radial distance between the ends of the prongs 94 is increased. With the distal end of the support struts 84 disposed in the recessed portion 38, and with the actuator 88 moving to the distal position along the elongated channel 86, the prongs 94 extend into the slots 48 in the wall 44 of the recessed portion 38. When the prongs 94 are inserted into the slots 48, the driver 80 may be used to operate the fastener 30 by rotating the handle 82, which rotation is translated through the supporting struts 84 and the prong struts 92 to the prongs 94 and to the head 34 of the fastener 30, thereby rotating the fastener 30. After a user is finished driving the fastener 30, the actuator 88 is withdrawn proximally along the elongated channel 86, thereby disengaging the prongs 94 from the slots 48 and releasing the driver 80 from being interlocked with the head 34 of the fastener 30.

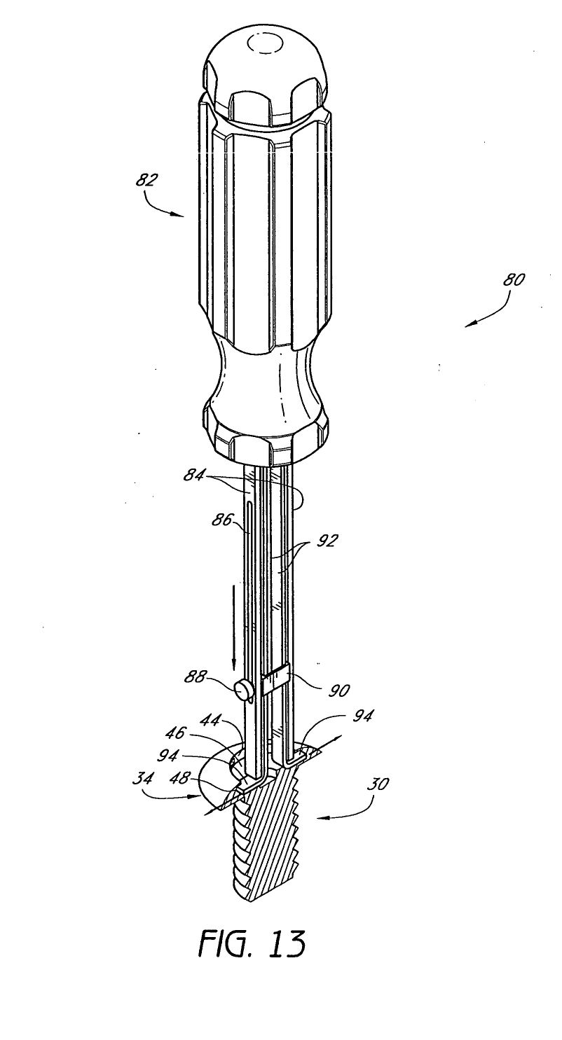

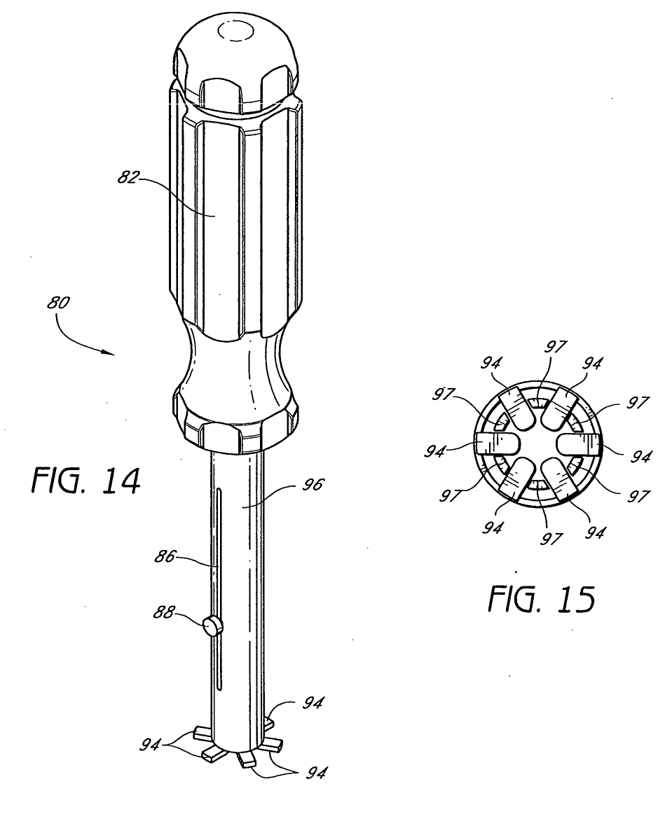

With reference to FIGS. 14 and 15, additional embodiments of the driver 80 are illustrated. In FIG. 14, the supporting struts 84 of FIG. 13 have been replaced with a substantially cylindrical supporting strut 96, which substantially encases the prong struts 92. The cylindrical supporting strut 96 preferably includes an elongated channel 86 that extends from a proximal portion of the cylindrical supporting strut 96 to a distal portion of the cylindrical supporting strut 96. Disposed within the elongated channel 86 is preferably an actuator 88 that is coupled to a collar 90 disposed within the cylindrical supporting strut 96. On the distal end of the driver 80, a plurality of prongs 94 extend radially with respect to an axis extending through the cylindrical supporting strut 96. The plurality of prongs 94 may be actuated by a collar 90 different than the collar 90 described above. With a plurality of prongs 94 circumferentially aligned along the cylindrical supporting strut 96, the collar 90 may be constructed as a cone, which, when slid distally by the actuator 88, engages the respective prong struts 92, forcing the prong struts against the inward surface of the cylindrical supporting strut 96.

FIG. 15 illustrates a bottom view of one embodiment of a driver 80 having a cylindrical supporting strut 96 and a plurality of circumferentially disposed prongs 94. In one embodiment, a plurality of guides 97 may be disposed on the distal end of the cylindrical supporting strut to separate and direct the prongs 94 as they are extended and withdrawn radially. The guides 97 may include a plurality of discontinuous protrusions disposed circumferentially along the distal end of the cylindrical supporting strut 96. The prongs 94 are preferably disposed between the discontinuous portions of the guides 97. In this way, the prongs 94 may be guided when extended radially into the slots 48 of the fastener 30.

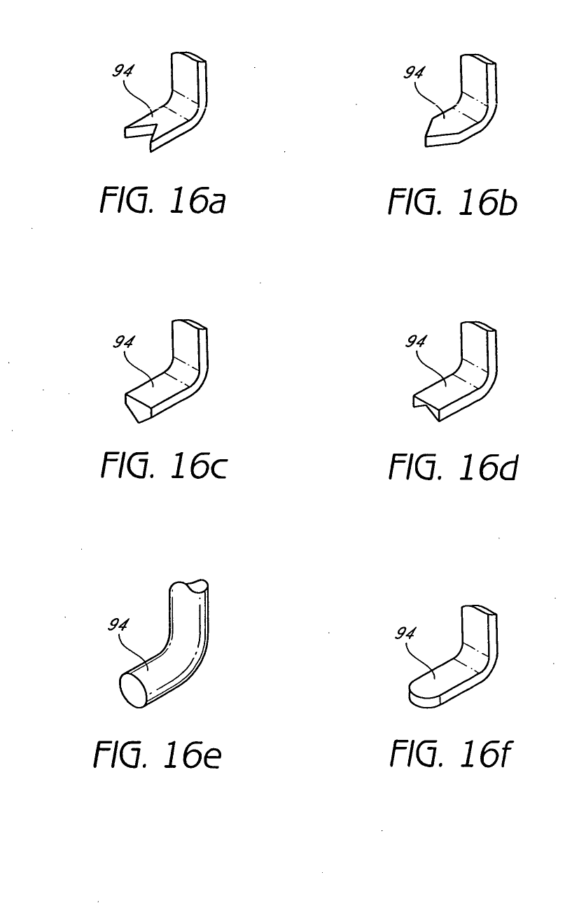

FIGS. 16A-16F illustrate various embodiments of prongs 94 with various shapes to be inserted into corresponding slots 48 of the fastener 30. With reference to FIGS. 16A, 16B, and 16F, the distal tip of the prong 94 may be modified to engage corresponding shapes of the slot 48. In FIGS. 16C, 16D, and 16E, the cross-sectional shape of the prong 94 tip may be modified for corresponding slots 48 within the head 34. For example, the slots 48 may be cylindrical, thereby permitting the prong 94 of FIG. 16E to be inserted therein. In another embodiment, the slot 48 may include a triangular protrusion extending from the base of the slot 48, thereby requiring a prong such as the one illustrated in FIG. 16D to be inserted therein. The illustrated embodiments of the tips of the prongs 94 are not intended to encompass all of the possible shapes and configurations of prong tips, and are provided only as examples of various shapes and configurations of the tips of the prongs 94.

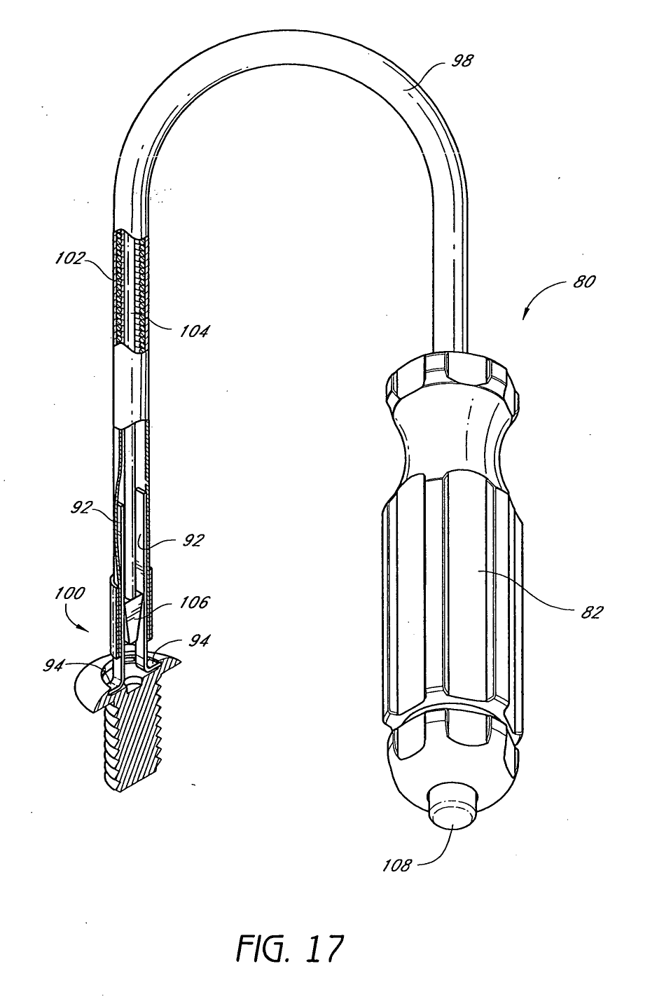

With reference to FIG. 17, another embodiment of the driver 80 is illustrated. In this embodiment, a handle 82 is provided on a proximal end of the driver 80. Extending from a distal end of the handle 82 is a flexible elongated tube having a plurality of prongs 94 extending from a distal end 100 thereof. The elongated flexible tube 98 is preferably configured to translate rotational movement of the handle 82 to the distal end 100 of the elongated flexible tube 98. The elongated flexible tube 98 preferably includes a spring coil 102 disposed therein to provide axial and radial integrity of the elongated flexible tube 98 and to limit kinking of the tube 98. Disposed within the spring coil 102 is preferably a flexible rod 104 that extends from a proximal end of the handle 82 to an actuating wedge 106 disposed in the distal end 100 of the elongated flexible tube 98. The flexible rod 104 is preferably connected to an actuating member 108 on the handle 82. In FIG. 17, the actuating member 108 is a button disposed on the proximal end of the handle 82. When the actuating member 108 is depressed, distal movement of the actuating member 108 is translated through the flexible rod 104 to the actuating wedge 106. Distal movement of the actuating wedge 106 forces a plurality of prong struts 92 disposed in the distal end 100 of the elongated flexible tube 98 against the wall of the distal end 100 of the elongated flexible tube 98. Although the prong struts 92 of FIG. 17 are depicted as extending partially through the elongated flexible tube 98, in some embodiments, the struts 92 extend the length of the flexible tube 98 to the handle 82. Movement of the prong struts 92 against the inner wall of the distal end 100 moves the prongs 94 extending from the distal end 100 radially apart, permitting the prongs 94 to engage the slots 48 of the fastener 30. When the actuating member 108 is withdrawn proximally, the flexible rod 104 and the actuating wedge 106 are withdrawn proximally, thereby permitting the prong struts 92 and the prongs 94 to be withdrawn radially inward and to disengage the slots 48 of the fastener 30.

In some embodiments, the prongs 94 can be hinged with respect to the prong struts 92 and configured to snap into place as the tool is inserted into the recess 38. This would advantageously work by placing indentations in the middle of the circumferential wall 44 that are configured to snap the prongs 94 into a deployed configuration upon insertion of the tool into the recess 38.

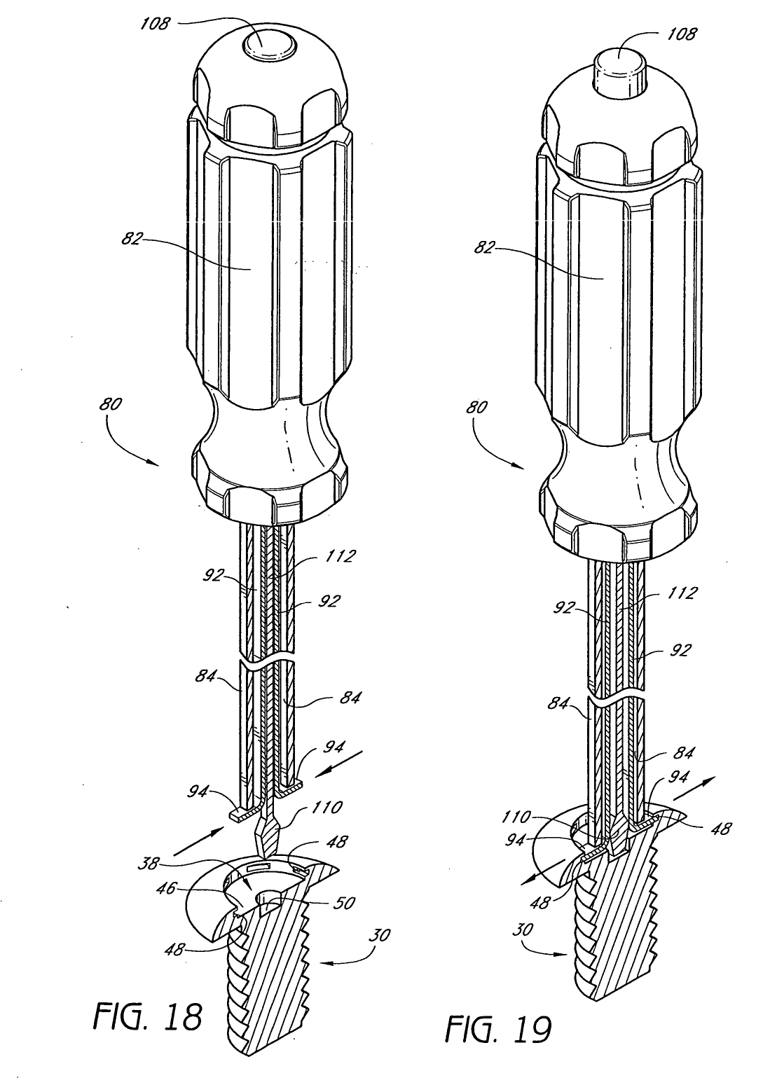

With reference to FIGS. 18 and 19, a driver 80 is illustrated having a handle 82 on a proximal portion of the driver 80 and an actuating member 108 on a proximal portion of the handle 82. The driver preferably includes a plurality of supporting struts 84 extending distally of the handle 82 and coupled thereto. Disposed within the supporting struts 84 are preferably a plurality of prong struts 92 that extend distally of the supporting struts 84 and are bent radially outward in about a 90 degree relation with respect to the prong strut 92, thereby constituting a plurality of prongs 94. Extending distally of the prongs 94 is preferably a biasing member 110. The biasing member 110 is preferably coupled to the actuating member 108 via a biasing member rod 112 that extends between the prong struts 92. The biasing member 110 preferably has an expanding configuration as it extends distally of the driver 80. In this embodiment, when the biasing member 110 is axially spaced from the prongs, the prong struts 92 are permitted to be biased inward and engage the biasing member rod 112. When the biasing member 110 is withdrawn proximally, the expanding edges of the biasing member 110 engage the prongs 94, and as the biasing member 110 is withdrawn further, the prongs 94 are forced radially outward into a deployed configuration, such as illustrated in FIG. 19. In this configuration, the prongs 94 are configured to be inserted into the slots 48 of the head 34. When the biasing member 110 is moved distally, the edges of the biasing member 110 permit the prongs 94 to be radially withdrawn, thereby disengaging the prongs 94 from the slots 48.

In one embodiment, a mechanism disposed within the handle 82 of the driver 80 may operate similar to a ballpoint pen mechanism that permits the withdrawal and protrusion of the ballpoint pen. Accordingly, when the driver 80 is brought adjacent to the fastener 30, and the biasing member is inserted into the recessed hole 50, as the biasing member 110 engages the recessed hole 50, the biasing member 110 is moved proximally to a point at which a spring or other mechanism withdraws the biasing member 110 and biasing member rod 112 proximally to a deployed configuration. The biasing member 110 preferably remains in the deployed configuration until the actuating member 108 releases the biasing member 110 from the deployed configuration, thereby permitting the biasing member 110 to move distally of the handle 82, thus releasing the prongs 94 from engagement within the slots 48. The actuating member may include a button that is in a depressed configuration 108 when the biasing member is in a pre-deployment configuration, and which extends proximally from the handle 82 when the biasing member 110 is in a deployed configuration. Accordingly, when the driver 80 is in a deployed configuration, a user can depress the actuating member 108 to release the biasing member 110 and the prongs 94 from engaging the fastener 30.

Although the present disclosure has been explained in the context of certain preferred embodiments and examples, it will be understood by those skilled in the art that the present disclosure extends beyond the specifically disclosed embodiments to other alternative embodiments and/or uses of the disclosure, obvious modifications and equivalents thereof. In addition, while a number of variations of the disclosure have been shown and described in detail, other modifications, which are within the scope of this disclosure, will be readily apparent to those of skill in the art based upon this disclosure. It is also contemplated that various combinations or subcombinations of the specific features and aspects of the embodiments may be made and still fall within the scope of the disclosure. Accordingly, it should be understood that various features and aspects of the disclosed embodiments can be combined with or substituted for one another in order to form varying modes of the present disclosure. Thus, it is intended that the scope of the present disclosure should not be limited by the particular disclosed embodiments described above.

What is claimed:

1. A security fastener comprising a head having a recessed top with a circumferential wall, said circumferential wall having a plurality of indentations therein spaced below an upper edge of the wall to permit engagement of the fastener by a tool with retractable projections matable with said indentations, said fastener further comprising a cap that is sized and configured to be received within the recessed top, said cap comprising an indentation in a side of the cap for providing a pry hole, said indentation being concealed when the cap is initially inserted into the recessed top.

2. The security fastener of claim 1, wherein the indentation in the cap is also on a top surface of the cap.

3. The security fastener of claim 1, wherein the indentation in the cap is also on a bottom surface of the cap.

4. The security fastener of claim 1, wherein the recessed top comprises a plurality of protrusions extending from the circumferential wall.

5. The security fastener of claim 1, further comprising adhesive on a portion of the cap.

6. The security fastener of claim 1, wherein the cap further comprises a protrusion extending from a side of the cap.

7. The security fastener of claim 1, wherein the cap comprises material above the indentation in the side of the cap that can be broken to expose the indentation.

8. A security fastener driver for driving a security fastener that comprises a head having a recessed top with a circumferential wall, said circumferential wall having a plurality of indentations therein spaced below an upper edge of the wall to permit engagement of the fastener by the driver, said fastener further comprising a cap that is sized and configured to be received within the recessed top, said cap comprising an indentation in a side of the cap for providing a pry hole, said indentation being concealed when the cap is initially inserted into the recessed top, said security fastener driver comprising a plurality of elongate arms that extend in a longitudinal direction, said elongate arms further comprising distal portions that extend generally transverse to the longitudinal direction and are movable generally transverse to the longitudinal direction such that said distal portions are configured to extend into the indentations of the circumferential wall and engage the fastener, said driver further comprising an actuatable member that is configured to move in the longitudinal direction to move said elongate arms transverse to the longitudinal direction to engage and disengage the distal portions with the fastener.

9. The security fastener driver of claim 8, further comprising a cylindrical supporting strut that substantially encloses the elongate arms.

10. The security fastener driver of claim 9, further comprising a plurality of guides toward the distal end of the cylindrical supporting strut for guiding the distal portions of the elongate arms.

11. The security fastener driver of claim 8, further comprising a flexible portion between a handle of said driver and said distal portions.

12. The security fastener driver of claim 8, wherein the actuatable member is connected to a button located on a handle of said driver.

13. The security fastener driver of claim 8, wherein the driver comprises six elongate arms.

14. The security fastener driver of claim 8, wherein the distal portions extend at an angle of about 90 degrees with respect to the longitudinal direction.

15. The security fastener driver of claim 8, wherein the distal portions are generally cylindrically-shaped.

16. A method of using a security fastening system, comprising:
providing a security fastener comprising a head having a recessed top with a circumferential wall, said circumferential wall having a plurality of indentations therein spaced below an upper edge of the wall to permit engagement of the fastener by a driver, said fastener further comprising a cap that is sized and configured to be received within the recessed top, said cap comprising an indentation in a side of the cap for providing a pry hole, said indentation being concealed when the cap is initially inserted into the recessed top;
providing a security fastener driver comprising a plurality of elongate arms that extend in a longitudinal direction, said elongate arms further comprising distal portions that extend generally transverse to the longitudinal direction and are movable generally transverse to the longitudinal direction such that said distal portions are configured to extend into the indentations of the circumferential wall and engage the fastener, said driver further comprising an actuatable member that is configured to move in the longitudinal direction to move said elongate arms transverse to the longitudinal direction to engage and disengage the distal portions with the fastener;
advancing a distal end of the driver into the recessed top; and
moving the actuatable member in the longitudinal direction to move the distal portions of the elongate arms transverse to the longitudinal direction and to engage the indentations in the circumferential wall.
